(19) United States
(12) Patent Application Publication
(10) Pub. No.: US 2006/0066187 A1
(43) Pub. Date: Mar. 30, 2006

(54) Lock mechanism for cabinet

(76) Inventor: Ching-Chang Chang, Pingtung County (TW)

Correspondence Address: BIRCH STEWART KOLASCH & BIRCH, PO BOX 747, FALLS CHURCH, VA, 22040-0747, US

(21) Appl. No.: 10/949,408

(22) Filed: Sep. 27, 2004

(51) Int. Cl. E05B 65/46

(52) U.S. Cl. 312/219

(57) ABSTRACT

Provided is a lock mechanism mounted on an inner wall in a rear of a cabinet. The mechanism comprises a longitudinal slide with first beads formed therealong, a rotatable connecting member connected to a top connecting block, a lock, a link interconnected the connecting member and the lock, sleeving blocks spaced apart along the slide, catches pivotably disposed in the sleeving blocks, and detents each secured to a rear end of a drawer. Pulling one drawer will counterclockwise pivot the catch to push a ball of the sleeving block into a gap between upper and lower beads below the first beads to push the upper bead upwardly and the lower bead downwardly respectively, and move the first beads downwardly to clear the ball proximate the catch from the upper and the lower beads for locking each of the remaining drawers.

### FIELD OF THE INVENTION

The present invention relates to locks and more particularly to a lock mechanism mounted in a cabinet having a plurality of drawers in which a pulling for opening one drawer prohibits the remaining drawers from being open by another pulling (i.e., locked).

### BACKGROUND OF THE INVENTION

A conventional cabinet with a plurality of drawers is shown in FIGS. 1 and 2. As shown, recesses are provided on both sides of the drawer. A slide is provided in the recess. As such, the drawer is adapted to slide along side tracks of the cabinet by pulling or pushing. Also, a stop member is provided at an outer end of the track so that the drawer is prevented from being moved further outwardly. Moreover, the slide moves from a lower portion of the track to a higher portion of the track after pulling one drawer to a prescribed limit. Other drawers are locked since their movements are stopped by second stop members in the rear ends of the drawers when the slides move. The other drawers are free to slide again only after one drawer has been pushed to its original closed position. That is, opening of only one drawer at a time is permitted. However, if a person pulls two drawers whether intentionally or not the slides of the drawers also move the same because the second stop members are not designed to prohibit the sliding. As a result, both drawers are open. This has the danger of overturning the cabinet if there are many heavy things stored in the open drawers. Hence, a need for improvement exists.

### SUMMARY OF THE INVENTION

It is an object of the present invention to provide a lock mechanism mounted within a cabinet having a plurality of drawers, comprising a slide longitudinally provided on an inner wall in a rear of the cabinet; a plurality of spaced bead sections formed along the slide, each bead section having a plurality of spaced apart beads; a plurality of pairs of spaced upper and lower beads in which each pair is provided between two adjacent bead sections; a connecting block provided on a top of the slide; a stop member provided on a bottom of the slide; a rotatable connecting member having an inner end connected to the connecting block; a link connected to an outer end of the connecting member; a lock provided on a front surface of the cabinet and secured to an outer end of the link; a plurality of sleeving blocks spaced apart along the slide; a plurality of catches each pivotably provided in the sleeving block; and a plurality of detents each secured to a rear end of the drawer such that using a key to clockwise turn the link and the connecting member will push a ball of the connecting member outwardly to press the beads to disengage from a ball of the sleeving block for locking the drawers. To the contrary, pulling one drawer will counterclockwise pivot the catch to push a ball of the sleeving block into a gap between the upper and lower beads to push the upper bead upwardly and the lower bead downwardly respectively, and move the beads in the bead section downwardly to clear the ball proximate the catch from the upper and the lower beads for locking each of the remaining drawers.

The above and other objects, features and advantages of the present invention will become apparent from the following detailed description taken with the accompanying drawings.

### BRIEF DESCRIPTION OF THE DRAWINGS

FIG. 1 is an exploded view of a portion of a conventional cabinet for depicting lock mechanisms provided in the drawers and the stationary frame of the cabinet.

FIG. 2 is a side view of FIG. 1 for depicting a pulling of one drawer.

FIG. 3 is a schematic perspective view of a preferred embodiment of lock mechanism mounted in a cabinet according to the invention.

FIG. 4 is an exploded view of the lock mechanism of FIG. 3.

FIG. 5 is a side, phantom view of FIG. 3 schematically depicting a locked position of the lock mechanism in the cabinet.

FIG. 6 is a view similar to FIG. 5 depicting an opening operation of the drawer.

FIG. 7 is an enlarged side, phantom view of the catch and other adjacent parts depicting an unlocked position of one portion the lock mechanism.

FIG. 8 is a front, phantom view of the catch and the sleeving block shown in FIG. 7.

FIG. 9 is a view similar to FIG. 7 depicting a locked position of one portion the lock mechanism.

FIG. 10 is a front, phantom view of the catch and the sleeving block shown in FIG. 9.

FIG. 11 is an enlarged side, phantom view of the catch and other adjacent parts depicting an unlocked position of one portion the lock mechanism, i.e., one drawer is free to slide, and depicting a locked position of any of the other portions the lock mechanism, i.e., any one of the remaining drawers is prevented from moving.

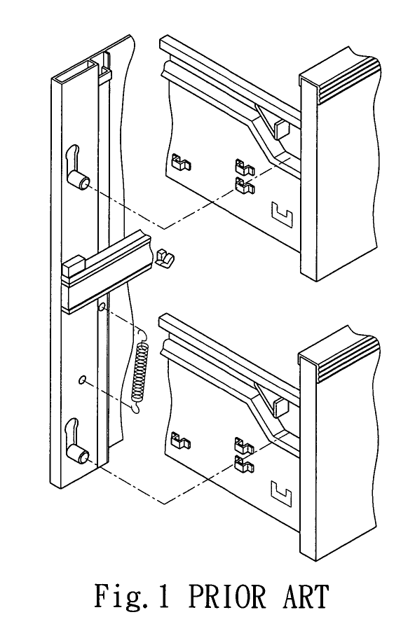

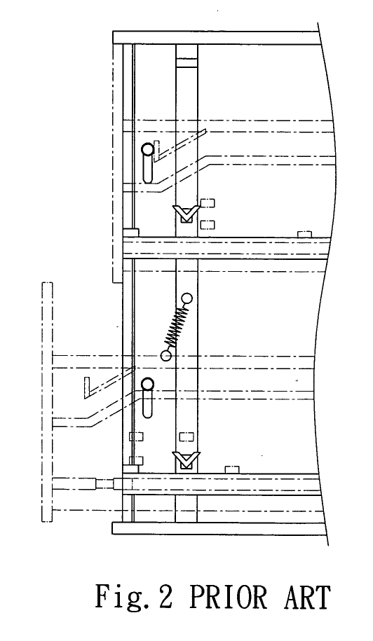

### DETAILED DESCRIPTION OF THE PREFERRED EMBODIMENTS

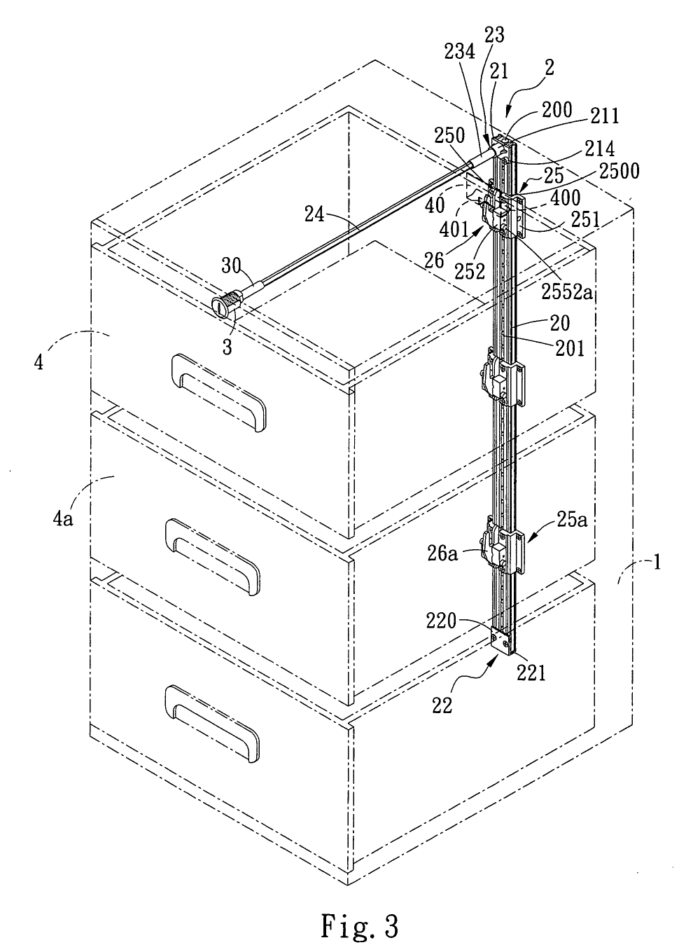

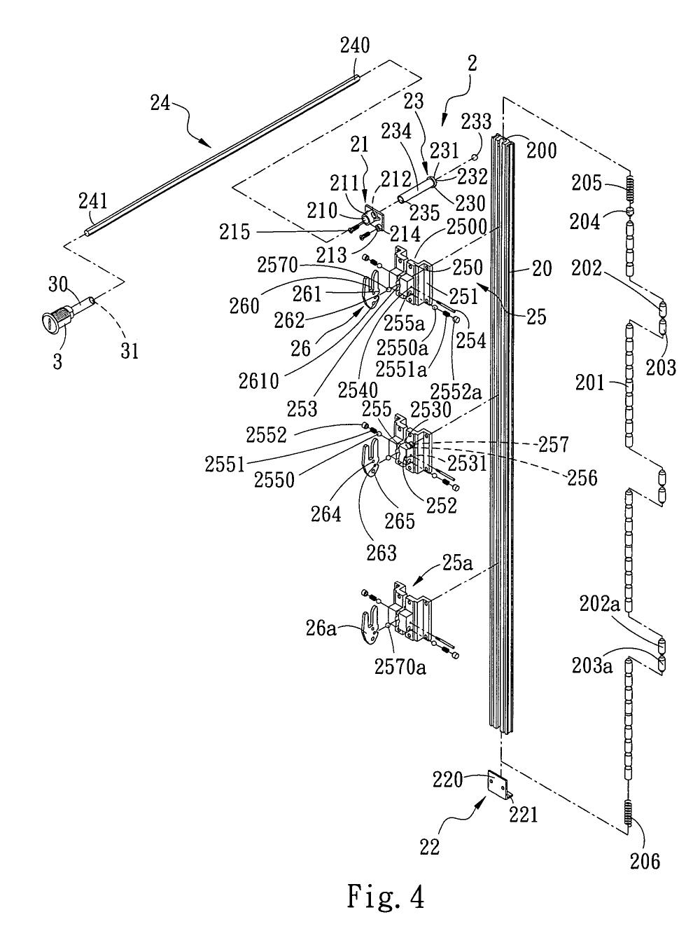

Referring to FIGS. 3 and 4, there is shown a lock mechanism 2 mounted in a cabinet 1 in accordance with a preferred embodiment of the invention. The lock mechanism 2 comprises a slide 20 longitudinally mounted on a central part of inner wall in the rear of the cabinet 1, a connecting block 21 provided on top of the slide 20, a stop member 22 provided on bottom of the slide 20, a rotatable connecting member 23 having an inner end connected to the connecting block 21, a link 24 connected to an outer end of the connecting member 23, a lock 3 provided on a front surface of the cabinet 1 and having a cylinder 30 projected rearwards to be secured to an outer end of the link 24, a plurality of sleeving blocks 25 equally spaced apart along the slide 20, and a plurality of catches 26 each provided in the sleeving block 25. The cabinet 1 has a plurality of drawers in which a pulling for opening one drawer 4 prohibits the remaining drawers 4a from being open by another pulling (i.e., locked) as the subject of the invention as detailed later.

The slide 20 comprises a longitudinal groove 200 having a half circular section. A plurality of bead sections are formed along the groove 200 in which beads 201 in each section are spaced apart. Each pair of a plurality of pairs of spaced upper bead 202 and lower bead 203 is provided between two adjacent bead sections. A top bead 204 is provided on the topmost bead 201. A top spring 205 is provided on the top bead 204 and a bottom spring 206 is provided under the bottommost bead 201. The connecting block 21 comprises a cylinder 211 having a bore 210, an indentation 212 provided proximate the cylinder 211 for releasably positioning the connecting member 23 therein, and two side studs 214 having a hole 213 so that a plurality of fasteners each may drive through the hole 213 for securing the connecting block 21 to the top of the slide 20. The L-shaped stop member 22 comprises a vertical member 220 and a horizontal member 221 having a length about the same as the width of the slide 20.

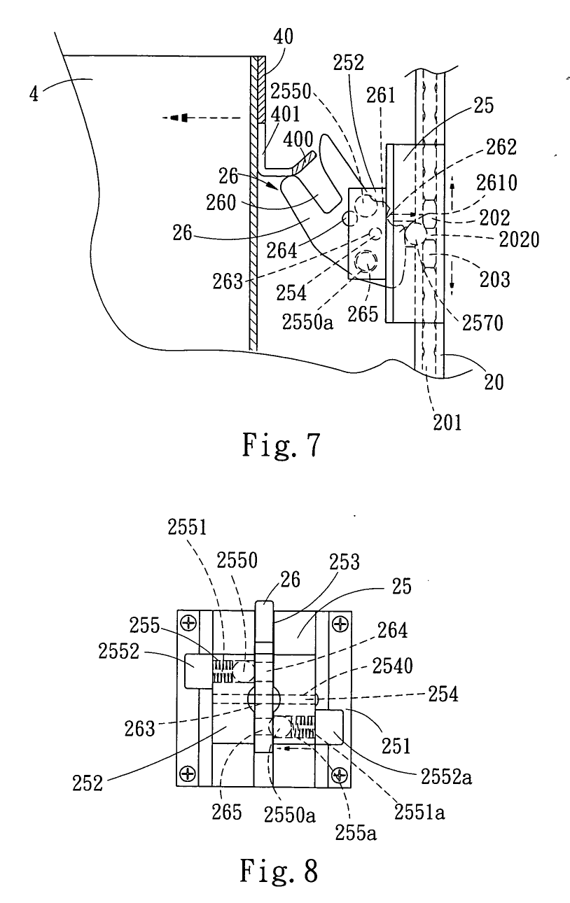

The connecting member 23 is an elongate member and comprises a flange 230 provided at an inner end, the flange 230 being conformed to the indentation 212, a cam 231 formed at the inner end being confined by the flange 230, a dent 232 provided on the cam 231, a ball 233 provided in the dent 232, and a bar 234 extended forwardly from the flange 230, the bar 234 having a lengthwise hole 235 of hexagonal section. The link 24 is of hexagonal section and is adapted to insert into the hexagonal hole 235 from its inner end 240 for fastening. An outer end 241 of the link 24 is adapted to insert into a hexagonal hole 31 of the cylinder 30 of the lock 30 for fastening. The sleeving block 25 is of U-shaped section and comprises a U-shaped body 250, a U-shaped longitudinal channel 2500 in a rear of the body 250, two side extensions 251 projected from the body 250, a forward raised member 252 on the body 251, a trough 253 longitudinally formed along the body 250 and the raised member 252 for dividing the sleeving block 25 into two equal parts, upper and lower stop elements 2530 and 2531 provided within the trough 253, an aperture 2540 provided in center of the raised member 252, a pin 254 inserted into the aperture 2540, two opposite holes 255 and 255a provided on upper and lower ramps of the raised member 252, balls 2550 and 2550a provided in the holes 255 and 255a respectively, springs 2551 and 2551a put on the balls 2550 and 2550a respectively, members 2552 and 2552a provided onto the springs 2551 and 2551a respectively, a bar 256 projected from a rear center of the raised member 252, the bar 256 having an aperture 257, and a ball 2570 provided in the aperture 257. The bifurcated catch 26 comprises an upward slot 260 between two branches for receiving a locking member 400 having a recess 401 of a detent 40 secured to a rear end of the drawer 4, upper and lower tabs 261 and 2610 and a dent 262 all provided in an inner side in which the upper tab 261 is urged against the upper stop element 2530 when the catch 26 pivots clockwise to its original position and the dent 262 is adapted to receive the ball 2570, and the lower tab 2610 is adapted to push the ball 2570 into a gap 2020 (as shown in FIG. 7) between the upper bead 202 and the lower bead 203 to push the upper bead 202 upwardly and the lower bead 203 downwardly respectively when the catch 26 pivots counterclockwise, a lower aperture 263 aligned with the aperture 2540 so that the pin 254 is adapted to insert into both the apertures 263 and 2540, and upper and lower holes 264 and 265 for receiving the balls 2550 and 2550a respectively such that the catch 26 is adapted to pivot on the pin 254 in the raised member 252 when the catch 26 is pivotably disposed in the trough 253. Also, the slide 20 passes through the channels 2500. The extensions 251 are secured to the internal frame of the cabinet 1. As an end, the drawers 4 and 4a are adapted to slidably receive in the frame of the cabinet 1.

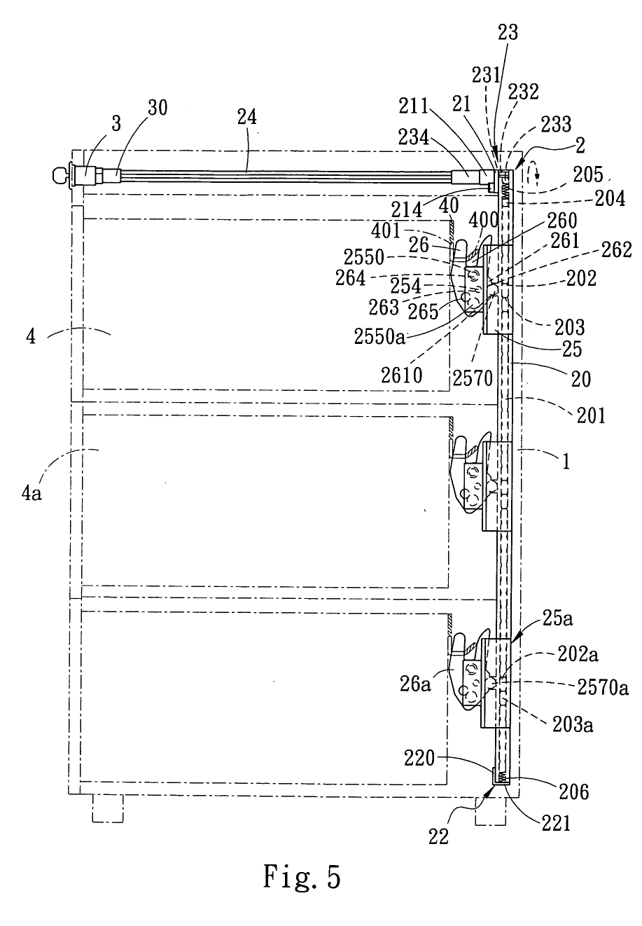

Referring to FIG. 5 in conjunction with FIGS. 3 and 4, the drawers 4 and 4 are disposed in a closed position with the sleeving blocks 25 secured to the slide 20. Next, a person may insert a key into the cylinder 30 of the lock 3 to clockwise turn the link 24 and thus the connecting member 23. And in turn, the ball 233 is pushed outwardly to press the beads 201 to disengage from the ball 2570. As a result, the drawers 4 and 4a are locked.

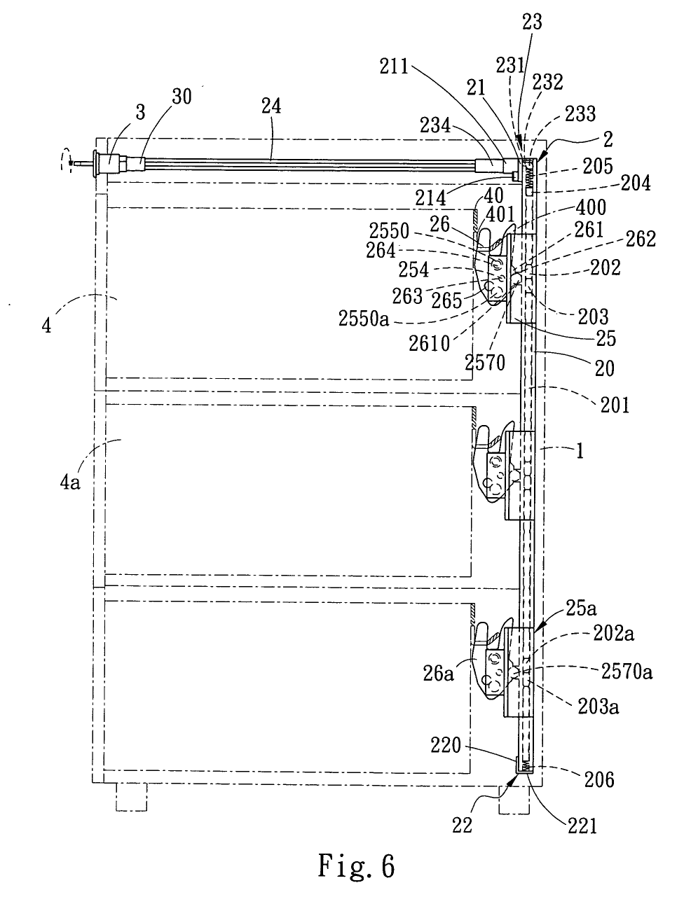

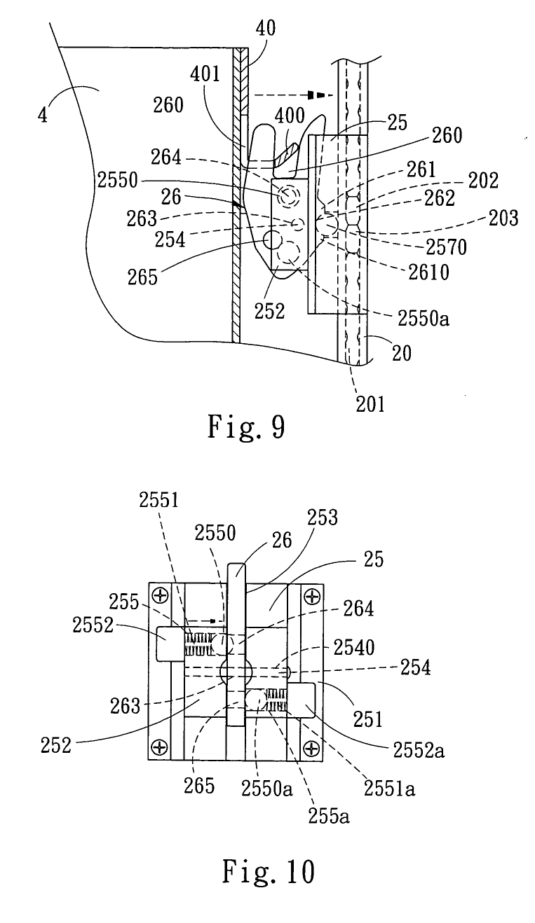

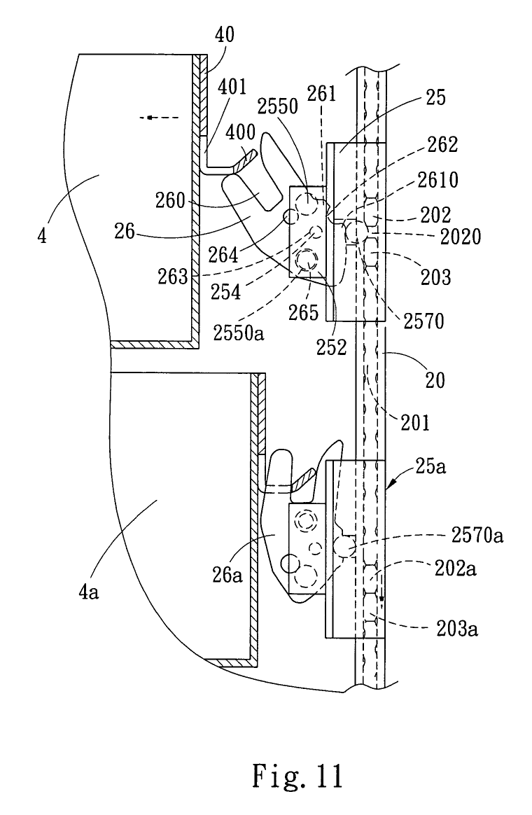

Referring to FIGS. 6, 7, 8, 9, 10, and 11, an opening operation of one drawer 4 will be described in detailed below. Insert a key into the cylinder 30 of the lock 3 to counterclockwise turn the link 24 and thus the connecting member 23. And in turn, the ball 233 returns into the dent 262, thereby causing the beads 201 to return to its original positions. Also, the ball 2570 is proximate a gap 2020 between the upper and lower beads 202 and 203. The ball 2550 falls into the upper hole 264 (see FIG. 8). Next, pull the drawer 4 and thus the detent 40. And in turn, the locking member 400 contacts the catch 26 to counterclockwise pivot the catch 26 on the pin 254. The lower tab 2610 then pushes the ball 2570 into the gap 2020 and the lower ball 2550a enters the lower hole 265 (see FIGS. 9 and 10). In addition, for the drawer 4a responsive to pushing the ball 2570 into the gap 2020 the beads 201 move downwardly to clear the ball 2570 at the side of the catch 26a from the upper and the lower beads 202a and 203a. As a result, the drawer 4a is still locked, i.e., all drawers 4a other than the open drawer 4 are locked (see FIG. 11).

While the invention herein disclosed has been described by means of specific embodiments, numerous modifications and variations could be made thereto by those skilled in the art without departing from the scope and spirit of the invention set forth in the claims.

What is claimed is:

1. A lock mechanism for a cabinet having a plurality of drawers, comprising:
a slide longitudinally disposed on an inner wall in a rear of the cabinet;
a plurality of spaced bead sections formed along the slide, each bead section having a plurality of spaced apart beads;
a plurality of pairs of spaced upper and lower beads in which each pair is disposed between two adjacent bead sections;
a connecting block disposed on a top of the slide;
a stop member disposed on a bottom of the slide;
a rotatable connecting member having an inner end connected to the connecting block;
a link connected to an outer end of the connecting member;
a lock disposed on a front surface of the cabinet and secured to an outer end of the link;
a plurality of sleeving blocks spaced apart along the slide;
a plurality of catches each pivotably disposed in the sleeving block; and
a plurality of detents each secured to a rear end of the drawer,
whereby pulling one drawer will counterclockwise pivot the catch to push a first ball of the sleeving block into a gap between the upper and lower beads to push the upper bead upwardly and the lower bead downwardly respectively, and move the beads in the bead section downwardly to clear the first ball proximate the catch from the upper and the lower beads for locking each of the remaining drawers.

2. The lock mechanism for cabinet of claim 1, wherein the slide comprises a longitudinal groove with the bead sections and the pairs of upper and lower beads formed therealong, further comprising a top bead member disposed on the topmost bead, a first spring disposed on the top bead member, and a second spring disposed under the bottommost bead.

3. The lock mechanism for cabinet of claim 1, wherein the connecting block comprises a hollow cylinder, an indentation disposed proximate the cylinder, and two side studs having a lengthwise first hole.

4. The lock mechanism for cabinet of claim 1, wherein the stop member is of the L-shaped and comprises a vertical member and a horizontal member having a length about the same as the width of the slide.

5. The lock mechanism for cabinet of claim 1, wherein the connecting member is of elongate and comprises a flange disposed at an inner end, the flange being conformed to the indentation, a cam formed at the inner end being confined by the flange, a dent disposed on the cam, and a hollow bar extended forwardly from the flange, the bar having a lengthwise second hole of hexagonal section.

6. The lock mechanism for cabinet of claim 1, wherein the lock comprises a hollow cylinder extended rearwards, the cylinder having a hexagonal third hole, and the link is of hexagonal section and is adapted to insert its inner end into the hexagonal second hole of the bar of the connecting member for fastening and insert its outer end into the hexagonal third hole of the cylinder of the lock for fastening.

7. The lock mechanism for cabinet of claim 1, wherein the sleeving block is of U-shaped section and comprises a body, a longitudinal channel disposed in a rear of the body, two side extensions, a forward raised member, a trough longitudinally formed along the raised member for dividing the sleeving block into two equal parts, upper and lower stop elements disposed within the trough, a first aperture disposed in a center of the raised member, a pin inserted into the first aperture, two opposite fourth holes disposed on upper and lower ramps of the raised member, two spring loaded second balls disposed in the fourth holes, two members disposed onto the spring loaded second balls, a bar member projected from a rear center of the raised member, the bar member having a second aperture, and the first ball disposed in the second aperture.

8. The lock mechanism for cabinet of claim 1, wherein the bifurcated catch comprises an upward slot between its branches, upper and lower tabs disposed in its inner side, a dent member disposed in its inner side, a lower third aperture aligned with the first aperture so that the pin is adapted to insert into the third and the first apertures, and upper and lower fifth holes for receiving the spring loaded second balls respectively.
